(19) United States
(12) Patent Application Publication
(10) Pub. No.: US 2007/0296327 A1
(43) Pub. Date: Dec. 27, 2007

(54) Planar Discharge Lamp And Lighting Device

(75) Inventors: Hidetoshi Yano, Ehime-ken (JP); Keiichi Kutsuna, Ehime-ken (JP)

Correspondence Address: BANNER & WITCOFF, LTD., 1100 13th STREET, N.W., SUITE 1200, WASHINGTON, DC, 20005-4051, US

(73) Assignee: HARISON TOSHIBA LIGHTING CORPORATION, Imabari-shi (JP)

(21) Appl. No.: 11/597,322

(22) PCT Filed: May 24, 2005
(86) PCT No.: PCT/JP05/09400

§ 371 Date: Nov. 22, 2006

(30) Foreign Application Priority Data
May 26, 2004 (JP) 2004-156256

(51) Int. Cl. H01J 17/49

(52) U.S. Cl. 313/485

(57) ABSTRACT

A planar discharge vessel is composed of a front board 1 made of translucent glass plate and a rear board 2 made of translucent glass plate facing to the front board 1 with a certain distance, a side wall 3 and frit glass 4, which joins a periphery of the front board 1 and the rear board 2 via a side wall 3 to form a planar discharge vessel. Phosphor layers 5a, 5b are formed on an inner surface of the front board 1 and rear board 2 and convert an ultraviolet ray radiated from the discharge medium through discharge into visible light. The external electrode 6, to which a high voltage is applied and the external electrode 7, to which a low voltage is applied are arranged alternately on the outer surface of the rear board 2. A plurality of elongated spacers 8 are arranged at an equal pitch between the front board 1 and the rear board 2 keeping a distance between the front board 1 and the rear board 2 substantially constant and thereby preventing the lamp vessel from breaking due to a pressure difference between inside and outside of the discharge vessel. The linear spacer 8 is located within the maximum width of the external electrode 6, with which each electrode 6 is divided into two in the appearance. Each discharge space is lighted stably by the electrode 6, which is partly exposed to each of the discharge spaces divided by the linear spacer 8 and which is operated as the electrode 10 of each discharge space.

### TECHNICAL FIELD

The present invention relates to a planar discharge lamp and to a lighting device.

### BACKGROUND TECHNOLOGY

In recent years, a planar discharge lamp having a discharge space formed within a hermetically sealed planar glass vessel has been developed for a fluorescent lamp used for a back light source with large sizing of a liquid crystal displays. In the planar discharge lamp, a phosphor film is formed on an inner surface of the glass vessel and a discharge medium composed of a mixed gas of xenon and rare gas, such as neon or argon, or a mixed gas of xenon, rare gas and mercury vapor is enclosed in the planular discharge space. A plurality of stripe-shaped discharge electrodes, which are parallel to each other, are formed on an upper and lower outer surface of the planar glass vessel.

A necessary potential difference is given across the adjacent discharge electrodes formed on the outer surface of the glass vessel, and thus discharge is generated through out the discharge space. An ultraviolet ray generated from xenon excites the phosphor film and emits light (Registered Japan Utility Model No. 3015262).

In the mean time, such planar discharge lamp is required to have a large area and a small thickness as the size of liquid crystal display becomes large. However, a glass vessel having the large area and the small thickness is readily broken by an atmospheric pressure. Thus, the planar discharge lamp is known, which is provided with spacers between a front board and a rear board composing the planar glass vessel, (Japan Publication of Unexamined Patent Application No. 2003-45376).

In the prior art, discharge electrodes are formed on the outer surface of the rear board composing the glass vessel. Each electrode is composed of a pair of stripe-shaped parallel electrodes divided into two along the longitudinal direction in order to secure uniform light emission. Spacers provided between front board and rear board are located between these pair of electrodes.

In the conventional discharge lamps described, the stripe shaped electrodes are produced by screen printing using conductive paste. However, when a width of electrode is smaller, it is difficult to produce the electrodes with constant width using the printing with the conductive paste because a printing screen is choked with the paste. Thus, a narrow portion of the electrode is apt to make disconnection resulting in degradation of the lamp quality. Besides, when electrode becomes long due to the large size of the lamp, the voltage applied at a feeding point is decreasing at a portion where a distance from the feeding point is increasing due to a resistance loss of the electrode, which results in a voltage deficiency at an end point of the lamp. As the result, the problem occurs that uniform brightness cannot be obtained, because the brightness of the lamp is decreasing as the distance from the feed point is increasing.

### DISCLOSURE OF THE INVENTION

The present invention is made to solve the above-mentioned problems.

It is an object of the present invention to provide a planar discharge lamp having higher reliability in lighting and higher luminance.

A planar discharge lamp according to an embodiment of the present invention includes, a planar discharge vessel composed of a translucent front board and a rear board facing to each other inside of which is hermetically sealed and a discharge medium is enclosed therein, spacers arranged substantially parallel to each other in a gap between the front board and the rear board thereby composing a plurality of elongated discharge spaces, and elongated external electrodes provided on an inner wall or on an outer wall of the rear board along the spacers so as to not to contact with the discharge medium, wherein the external electrodes are so arranged that an electrode on which a high voltage is applied and an electrode on which a low voltage is applied are alternately arranged, that the longitudinal direction of the external electrodes and the longitudinal direction of the spacers are nearly parallel, and that the joint surface of the spacers and the rear board is located within the maximum width of the external electrode.

In a planar discharge lamp according to the embodiment of the present invention, the planar discharge vessel is composed of translucent glass.

Further, in a planar discharge lamp according to an embodiment of the present invention, the spacer is composed of a translucent glass.

Further, in a planar discharge lamp according to an embodiment of the present invention, the external electrode is band-shaped, having a maximum width, a part of which overlaps with each of the discharge spaces on both sides of the spacer to form a discharge electrode.

Further, in a planar discharge lamp according to an embodiment of the present invention, a high frequency sine wave voltage or a high frequency pulse voltage is applied between the external electrodes on which the high voltage is applied and external electrodes on which the low voltage is applied.

Further, in a planar discharge lamp according to the embodiment of the present invention, the spacer has a cross section across the longitudinal direction, the shape of which is a square, a rectangular, a trapezoid, an inverted trapezoid, a tube shape, a rectangular, an inverted rectangular, a convex shape, or a concave shape.

Further, in a planar discharge lamp according to an embodiment of the present invention, the spacer has a shape of a line, a rectangle, a sine wave, triangular wave, or rectangular wave, when observed from the rear board side.

Further, in a planar discharge lamp according to the embodiment of the present invention, the external electrode meanders along a sine wave shape, a triangular wave shape or a rectangular wave shape. The external electrode, however, has a maximum width, a part of which overlaps with each of the discharge spaces on both sides of the spacer to form a discharge electrode.

Further, in a planar discharge lamp according to the embodiment of the present invention, the spacer is composed of a translucent hollow tube, in which the discharge medium is enclosed and on both ends of which the external electrodes are provided.

Further, in a planar discharge lamp according to the embodiment of the present invention, the spacer has a cross section of a circular cylinder shape or a rectangular cylinder shape.

Further, in a planar discharge lamp according to the embodiment of the present invention, the spacer is produced integrally with the front board.

Further, in a planar discharge lamp according to the embodiment of the present invention, the front board is formed in a concave and convex shape or in a wave shape, and a plurality of discharge spaces are formed in the planar discharge vessel by joining the convex portions with the rear boards.

Further, in a planar discharge lamp according to the embodiment of the present invention, the joined portion of the convex portion and the rear board is formed along the external electrode and is located within the maximum width of the external electrode.

A lighting device according to an embodiment of the present invention is equipped with one of any above-mentioned planar discharge lamps as a light source.

With the embodiment of the present invention described, a stable light can be emitted from whole screen which was difficult in a structure with one electrode, because one external electrode is exposed in each of discharge space divided by the linear spacer and is used as an electrode in each discharge space by locating junction plane of the linear spacer and the rear board within the maximum width of external electrode provided at the center of the lamp.

Further, with the embodiment of the present invention, light can be emitted from the spacer portion which prevents planar discharge vessel from breaking under the atmospheric pressure. Thus, a uniform light emission can be attained at a light emission portion of the planar discharge lamp.

Further, with the embodiment of the present invention, processing of the external electrode during production can be much improved because there is no need for dividing the electrode into two and form a narrow external electrode.

Further, with the embodiment of the present invention, electric resistance of the external electrode is decreased and thus the heat loss at the external electrode is decreased, because a wider external electrode can be provided. As the result, the voltage drop at a portion distant from the feeding point can be minimized, and stable light emission at the end of the electrode facing the feeding point can be attained even when the length of the external electrode of the planar discharge lamp is increased due to the large size screen.

### BRIEF DESCRIPTION OF THE DRAWINGS

FIG. 1 is a perspective view of a planar discharge lamp according to a first embodiment of the present invention.

FIG. 2 is a cross section of an electrode provided with a concave portion on its side used in the first embodiment of the present invention.

FIG. 3 is a cross section of an electrode having a band shape, in which a width at a center portion is made narrow, used in the first embodiment of the present invention.

FIG. 4 is a cross section of an electrode having a triangular wave shape used in the first embodiment of the present invention.

FIG. 5 is a partly abbreviated perspective view of a planar discharge lamp including a spacer having a trapezoid cross section used in the first embodiment of the present invention.

FIG. 6 is a partly abbreviated perspective view of a planar discharge lamp including a spacer having an inverted trapezoid cross section used in the first embodiment of the present invention.

FIG. 7 is a partly abbreviated perspective view of a planar discharge lamp including a spacer having a triangular cross section used in the first embodiment of the present invention.

FIG. 8 is a partly abbreviated perspective view of a planar discharge lamp including a spacer having an inverted triangular cross section used in the first embodiment of the present invention.

FIG. 9 is a partly abbreviated perspective view of a planar discharge lamp including a spacer having a circular cross section used in the first embodiment of the present invention.

FIG. 10 is a partly abbreviated perspective view of a planar discharge lamp including a spacer having a hollow circular cross section used in the first embodiment of the present invention.

FIG. 11 is a cross section parallel to the longitudinal direction of a spacer having a linear shaped bottom used in the first embodiment of the present invention.

FIG. 12 is across section parallel to the longitudinal direction of a spacer having a wave shaped bottom used in the first embodiment of the present invention.

FIG. 13 is across section parallel to the longitudinal direction of a spacer having a square wave shaped bottom used in the first embodiment of the present invention.

FIG. 14 is a cross section parallel to the longitudinal direction of a spacer having a disconnected linear shaped bottom used in the first embodiment of the present invention.

FIG. 15 is a perspective view of a planar discharge lamp according to a second embodiment of the present invention.

FIG. 16 is a top view of the planar discharge lamp according to the second embodiment of the present invention.

FIG. 17 is a cross section of a planar discharge lamp according to the second embodiment of the present invention.

FIG. 18 is a cross section along an A-A′ line in FIG. 16.

FIG. 19 is a perspective view seen from the rear side of a third embodiment of the present invention.

FIG. 20 is a perspective view seen from the front side of a third embodiment of the present invention.

### DETAILED DESCRIPTION OF THE INVENTION

Hereinafter, embodiments of the present invention are explained referring to the figures.

### First Embodiment

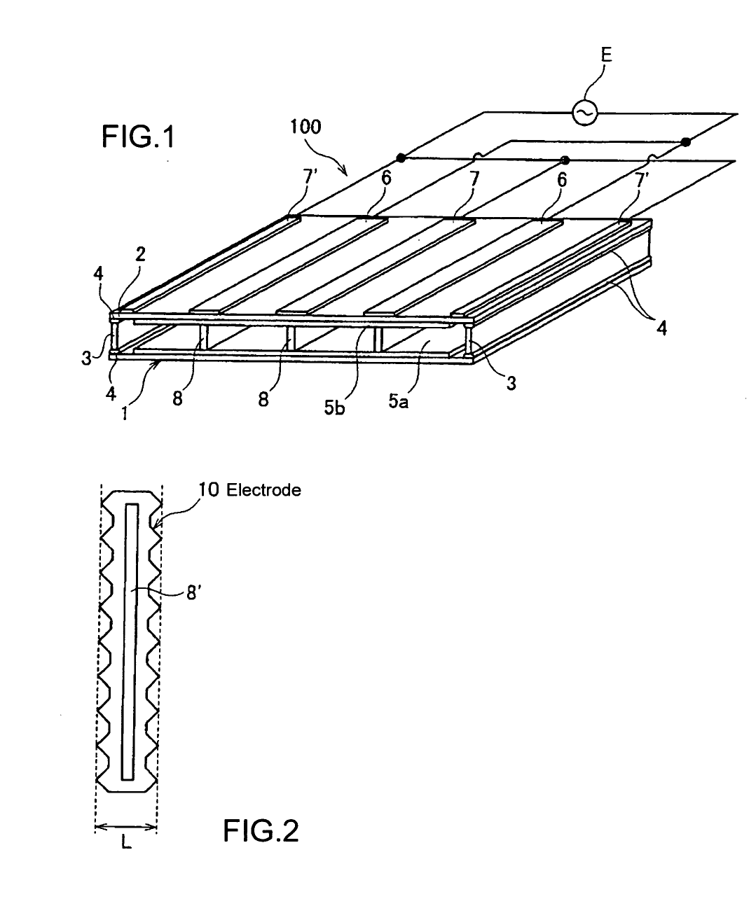

FIG. 1 is a perspective view showing a planar discharge lamp according to a first embodiment of the present invention.

A planar discharge vessel is constructed by arranging a front board 1 and a rear board 2, each is composed of translucent glass plate, facing to each other with a substantially constant distance and the periphery portions of the two glass plates are adhered with frit glass 4 via a side wall 3. Here, the planar vessel may be made with a structure in which either glass board is formed in a tray shape omitting side wall 3, or, with a structure in which the periphery portion of the glass board is heated to be melt and is adhered without using frit glass.

Inside the planar discharge vessel, a single component or a mixture of two or more components of mercury vapor, xenon, krypton, argon, neon, or helium is enclosed with a sealing pressure of several kPa to several hundreds kPa as a discharge medium.

Phosphor layers 5a, 5b are formed on an inner side of the front board 1 and the rear board 2, which is illuminated by an ultraviolet ray radiated from the discharge medium when it is discharged. The ultraviolet ray is then converted into visible light. The same kind of the phosphor as used in ordinary lighting devices, in cold cathode fluorescent lamps, or in PDPs may be used. The phosphor is applied as a single component or as a mixture of several kinds of phosphor with different luminescent colors to form the phosphor layers 5a, 5b. The phosphors of different luminescent colors may be applied separately in stripe shape or in dot shape.

The phosphor layer 5a of the front board 1 from which light is emitted, is made, for example, of phosphor particles having average particle diameter (primary particle diameter) of about 2.5 μm or larger, which are applied as a thin layer with a thickness of 5 μm to 15 μm, in order to transmit the light from the phosphor without loss. On the other hand, the phosphor 5b of the rear board 2 from which light is not emitted, is made, for example, of phosphor particles having average particle diameter of about 2.5 μm or less, which are applied as a thick layer with a thickness of 30 μm to 100 μm, in order to increase the reflectivity and to introduce more light to the front board 1 side. Thus, visible light generated by the phosphor layer 5b is introduced more to the front board 1 side than to the rear board. A reflective layer composed of fine particle metal oxide may be provided between the rear board 2 and the phosphor layer 5b. Although, the phosphor layers 5a, 5b are provided on the inner surface of the both glass board 1, 2 as shown in the figure, either one of the phosphor layers can be omitted. Further, the both phosphor layers 5a, 5b of the front board 1 and the rear board 2 can be omitted to be used as a discharge lamp utilizing ultraviolet ray or visible light.

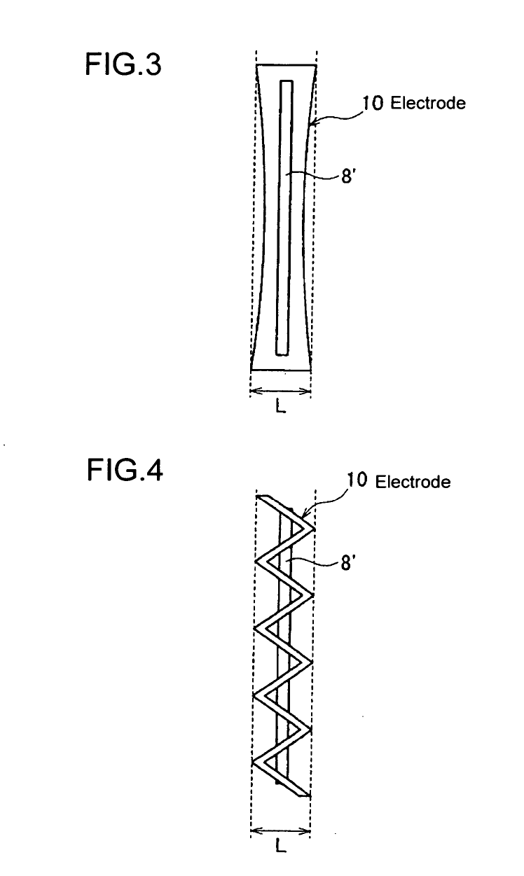

An external electrode 6, on which a high voltage is applied, and an external electrode 7, on which a low voltage is applied, are provided alternately on the outer surface of the rear board 2. The external electrodes 6 and 7 are formed in band shape as illustrated. However, they are not limited to have the band shape, but a various sorts of shapes may be adopted. For example, a shape with convex portions on both sides like the electrode 10 as shown in FIG. 2 may be adopted. They may be formed in band shape with the width at center portion is reduced as shown in FIG. 3. Or they may be formed in a triangular wave shape as shown in FIG. 4. However, these electrodes are formed in substantially a band shape extending along a longitudinal direction with a maximum width L. Here, in these figures, symbol 8′ denotes a spacer provided within the maximum width L of these electrodes, as described later.

Between the front board 1 and the rear board 2, a plurality of elongated plate like spacers 8 are located with equal spacing, to keep a spacing between the front board 1 and the rear board 2 constant and to prevent the implosion of the lamp due to the pressure difference between internal and external pressure of the discharge vessel. The plurality of spacers 8 is made, for example, of translucent glass, and they divide the discharge vessel to form a plurality of elongated discharge spaces.

Band shaped external electrodes 6, 7 are provided substantially in parallel on the central portion of the outer surface of the rear board 2. Among these external electrodes, a width of external electrodes 7′, 7′, provided on the both ends of the rear board 2 have substantially half a width of the external electrodes 6, 7, provided on the central portion. Thus, the width of each electrode becomes substantially equal at the central portion and at the both ends, which are formed in the plurality of discharge spaces divided by the spacer 8.

In the planar discharge lamp thus constructed, discharge is generated in each discharge space formed by dividing with elongated plate shape spacer 8 in the planar discharge vessel, when a high frequency sine wave voltage or a high frequency pulse voltage of frequency 10 kHz to 200 kHz is applied between the external electrode 6 of the high voltage side and the external electrode 7, 7′ of the low voltage side from a power source E. The ultraviolet ray radiated from the discharge medium is converted into visible light by the phosphor layer 5a, 5b and is utilized as a lighting device 100. Here, a rectangular wave voltage, or a triangular voltage etc. can be used as a pulse voltage waveform applied from the source E.

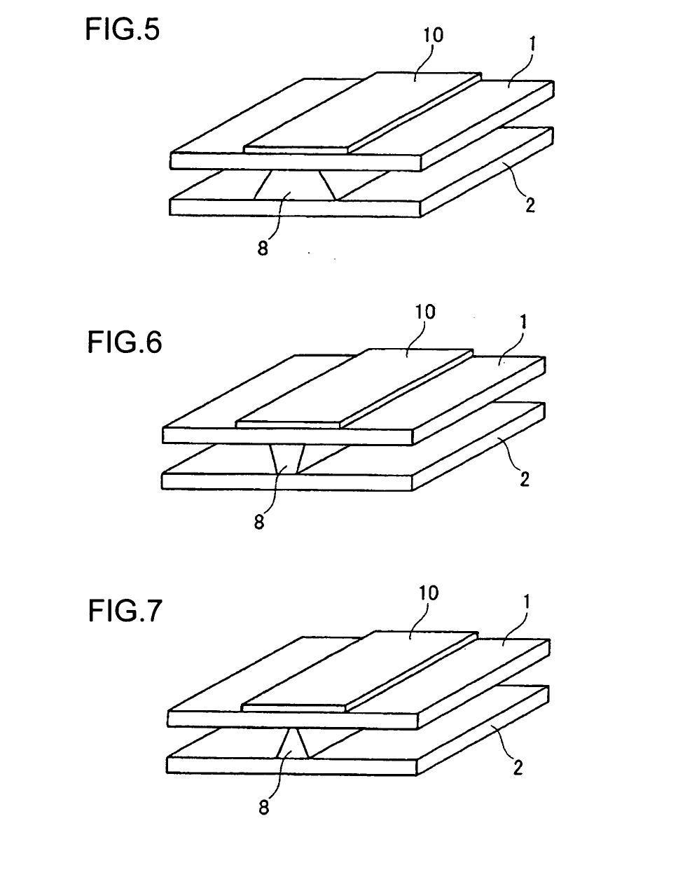

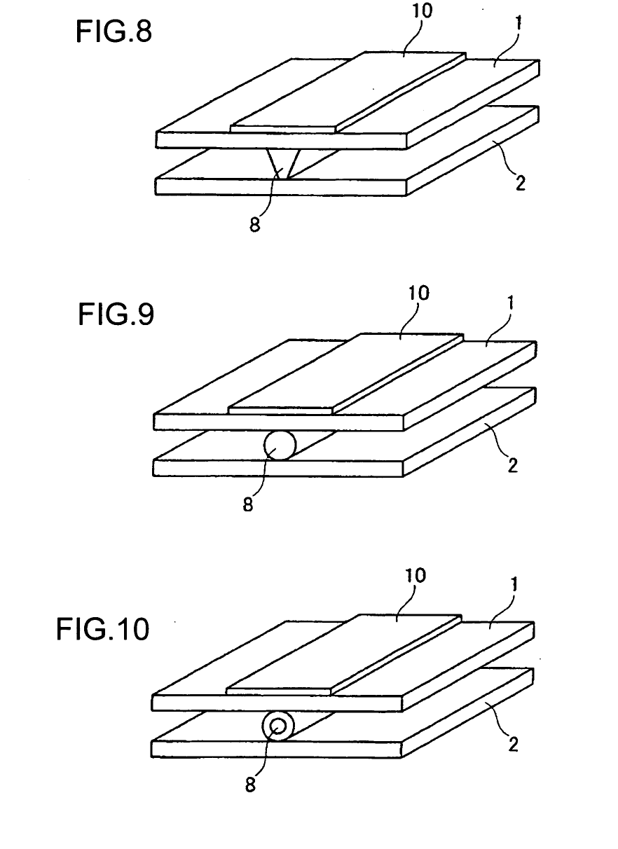

The spacer 8 may have a various shapes of a cross section, such as a trapezoid shown in FIG. 5, FIG. 6, a triangle shown in FIG. 7, FIG. 8, a circle shown in FIG. 9 or a tube shown in FIG. 10, in addition to a rectangular solid as shown in FIG. 1.

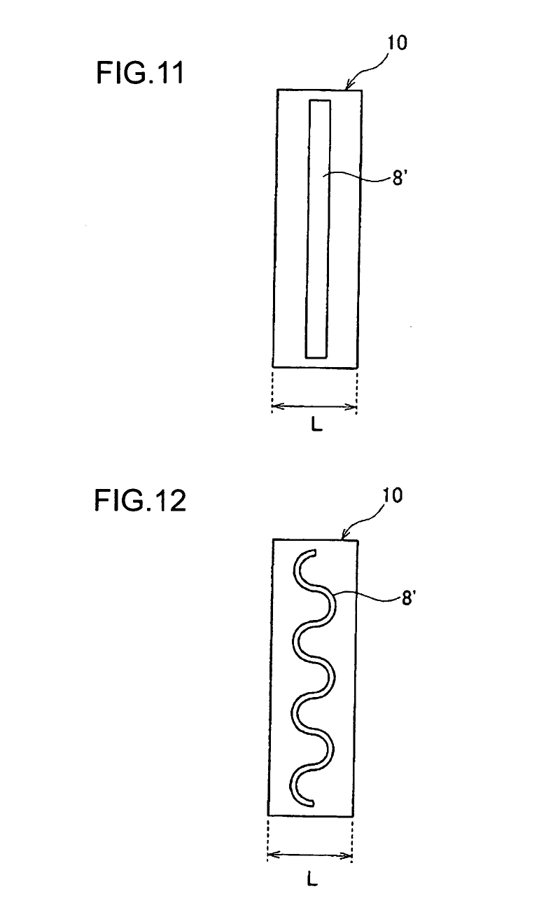

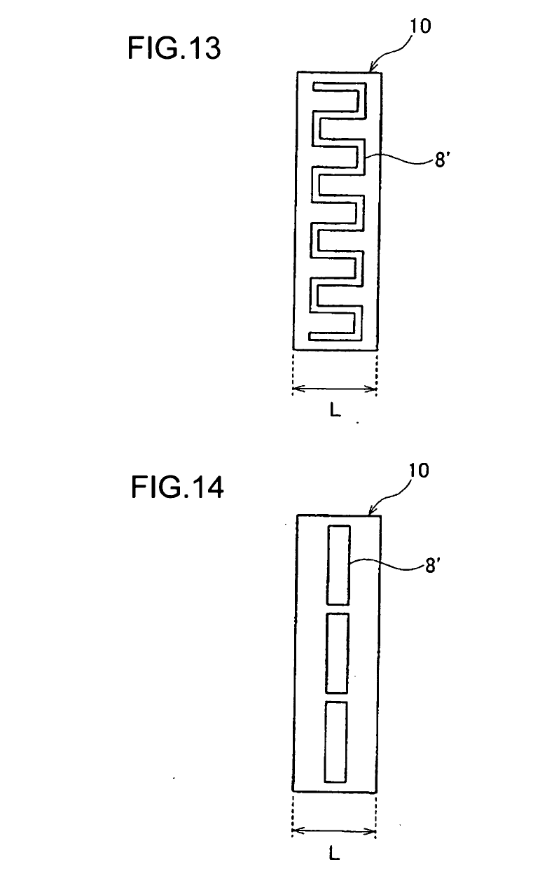

The spacer 8 has a bottom, which is a joint surface of the spacer 8 and the rear board 2, is formed generally in a continuous band shape, such as a linear band shape shown in FIG. 11, a wave shape shown in FIG. 12, or a rectangular wave shape shown in FIG. 13. However, the bottom of the spacer 8 may be a discontinuous band shape shown in FIG. 14. In each configuration, the longitudinal direction of the joint surface of the spacer 8 and the rear board 2 is substantially parallel with the longitudinal direction of the electrodes 6, 7, and the joint surface of the spacer 8 and the rear board 2 is located within the maximum width L. With this structure, one of the external electrodes 6 or 7 partly overlaps with each of the discharge space divided by the linear spacer 8 in the width direction, and thus operates as an electrode for each discharge space.

### Second Embodiment

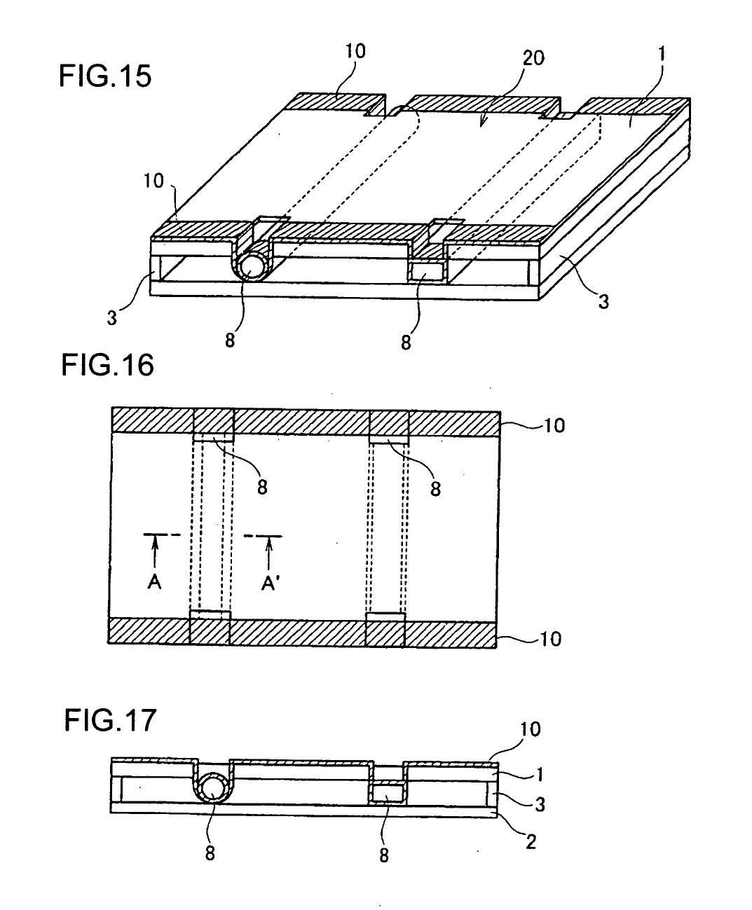

FIG. 15 to FIG. 17 respectively shows a perspective view, a top view, and a cross section view of the planar discharge lamp 20 according to a second embodiment of the present invention. FIG. 18 is a cross sectional view along a line A-A′ in FIG. 16. The spacer 8 provided between a front board 1 and a rear board 2 in order to prevent from implosion by atmospheric pressure is formed with a hollow tube such as a circular tube or a rectangular tube. Inside a discharge vessel composed of the front board 1, the rear board 2 and a side wall (not illustrated, formed on the four sides of the front board 1 and the rear board 2) is kept air tight, in which at least mercury or one or more kinds of rare gas is enclosed.

Further, inside the hollow spacer 8 is also kept air tight, in which mercury or one or more kinds of rare gas is enclosed. Here, the rare gas in the discharge vessel and in the spacer 8 is not necessarily the same one. A phosphor layer 9 is provided by applying it on the inner surface of the front board 1, the rear board 2 and the spacer 8, as shown in FIG. 18. In the present embodiment, a pair of electrodes 10, 10 is provided on the both ends of the front board 1. Here, the pair of electrodes 10, 10 may be provided on the rear board 2 or may be provided on both of the front board 1 and the rear board 2. The electrode 10, 10 provided on the front board or on the rear board and the electrode provided on the spacer 8 are unified, so that the light emitting portion of the front board 1 and the light emitting portion of the spacer 8 can be operated by the same power source.

In the planar discharge lamp 20 according to the embodiment of the present invention, the light emitting portion of the discharge vessel and the spacer 8 provided for preventing the implosion can be lighted simultaneously, and thus a uniform light emission over the entire light emitting plane can be obtained.

### Third Embodiment

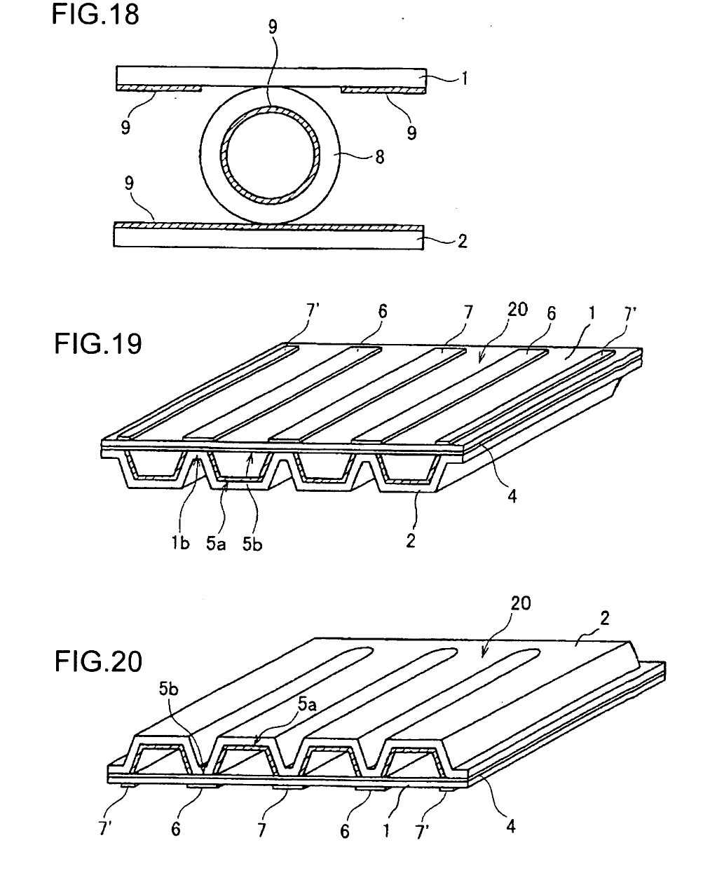

FIG. 19 and FIG. 20 are perspective views showing a planar discharge lamp 20 according to a third embodiment of the present invention, each of which is a perspective view of the planar discharge lamp 20 viewed from a rear board 2 side and from a front board 1 side respectively.

In this embodiment, a front board 1 composed of a translucent glass plate is deformed by heat processing to make the cross section concave and convex, and to make the convex portion 1b contact with the rear board 2 composed of a translucent glass plate to function as a spacer. That is, the front board 1 forms a plurality of elongated discharge spaces with the rear board 2 forming groove shaped concave portions. On the outer surface of the rear board 2, elongated band shaped external electrodes 6, 7 are formed. The joint surface of the convex portion 1b of the front board 1 and the rear board 2 is located within the maximum electrode width L of the external electrode 6 and 7, as is the case with the first embodiment. Phosphor layers 5a, 5b are applied on the inner surface of a gap between the front board 1 and the rear board 2.

The planar discharge lamp 20 thus constructed has an advantage of reducing production cost, because the front board 1 and the spacer can be made together by deforming the front board 1 with heat.

1. A planar discharge lamp comprising:
a planar discharge vessel composed of a translucent front board and a rear board facing to each other inside of which is hermetically sealed;
a discharge medium enclosed in the planar discharge vessel;
spacers arranged substantially parallel to each other in a gap between the front board and the rear board thereby composing a plurality of elongated discharge spaces; and
elongated external electrodes provided on an inner wall or on an outer wall of the rear board along the spacers so as to not to contact with the discharge medium;
wherein the external electrodes are so arranged that an electrode on which a high voltage is applied and an electrode on which a low voltage is applied are alternately arranged, that the longitudinal direction of the external electrodes and the longitudinal direction of the spacers are substantially parallel, and that a joint surface of the spacer and the rear board is located within a maximum width of the external electrode.

2. A planar discharge lamp according to claim 1, wherein the planar discharge vessel is composed of a translucent glass.

3. A planar discharge lamp according to claim 2, wherein the spacer is composed of a translucent glass.

4. A planar discharge lamp according to claim 3, wherein the external electrode is band-shaped, having a maximum width, a part of which overlaps with each of the discharge spaces on both sides of the spacer to form a discharge electrode.

5. A planar discharge lamp according to claim 4, wherein a high frequency sine wave voltage or a high frequency pulse voltage is applied between the external electrodes on which the high voltage is applied and external electrodes on which the low voltage is applied.

6. A planar discharge lamp according to claim 1, wherein the spacer has a cross section across the longitudinal direction, the shape of which is a square, a rectangular, a trapezoid, an inverted trapezoid, a tube shape, a rectangular, an inverted rectangular, a convex shape, or a concave shape.

7. A planar discharge lamp according to claim 2, wherein the spacer has a shape of a line, a rectangle, a sine wave, triangular wave, or rectangular wave, when observed from the rear board side.

8. A planar discharge lamp according to claim 7, wherein the external electrode meanders along a sine wave shape, a triangular wave shape or a rectangular wave shape and has a maximum width, a part of which overlaps with each of the discharge spaces on both sides of the spacer to form a discharge electrode

9. A planar discharge lamp according to claim 1, wherein the spacer is composed of a translucent hollow tube, in which the discharge medium is enclosed and on both ends of which the external electrodes are provided.

10. A planar discharge lamp according to claim 9, wherein the spacer has a cross section of a circular cylinder or a rectangular cylinder shape.

11. A planar discharge lamp according to claim 1, wherein the spacer is produced integrally with the front board.

12. A planar discharge lamp according to claim 11, wherein the front board is formed in a concave and convex shape or in a wave shape, and a plurality of discharge spaces are formed in the planar discharge vessel by joining the convex portions with the rear boards.

13. A planar discharge lamp according to claim 12, wherein the joint surface of the concave portion and the rear board is formed along the external electrode, and is located within the maximum width.

14. A lighting device according to claim 1, having a planar discharge lamp as a light source.
